(19) United States
(12) Patent Application Publication
(10) Pub. No.: US 2015/0347718 A1
(43) Pub. Date: Dec. 3, 2015

(54) METHOD FOR DETERMINING THE TOTAL ENERGY FOR DESOLVATING AN ANION-CATION PAIR AND INSERTING IT INTO THE ELECTRODE OF A SUPERCAPACITOR

(71) Applicant: IFP ENERGIES NOUVELLES, Rueil-Malmaison (FR)

(72) Inventors: Julio JOVER AZPURUA, Courbevoie (FR); Theodorus DE BRUIN, Paris (FR); Herve TOULHOAT, Herblay (FR)

(73) Assignee: IFP ENERGIES NOUVELLES, Rueil-Malmaison Cedex (FR)

(21) Appl. No.: 14/654,635

(22) PCT Filed: Sep. 17, 2013
(86) PCT No.: PCT/FR2013/052137

§ 371 Date: Jun. 22, 2015

(30) Foreign Application Priority Data
Oct. 29, 2012 (FR) 12 02895

(51) Int. Cl. G06F 19/00

(52) U.S. Cl. CPC G06F 19/701

(57) ABSTRACT

The invention is a device for sampling fluids under pressure from a well which comprises a chamber for retaining the fluid within a sample chamber (01). The chambers includes a first piston which allows or prevents fluid inflow into the lower part of the chamber. The first piston is displaced by means comprising an elastic element (20) disposed in a chamber filled with oil and connected to the piston by a rod (04). Sampled fluid transfer means allows control of the descent of a second piston (02) from the upper part to the lower part of the chamber so that the fluid remains at constant pressure in chamber during the transfer.

### CROSS REFERENCE TO RELATED APPLICATIONS

Reference is made to French Patent Application Serial Number 12/02.895 and PCT Application Serial Number 2013/052137 which applications are incorporated herein by reference in their entirety.

### BACKGROUND OF THE INVENTION

1. Field of the Invention

The present invention relates to the field of supercapacitors and, more generally concerns a method for simulating electrostatic interactions between an electrically charged adsorbent and an electrically charged adsorbate. In particular, the invention is a method for determining the total energy for desolvating an anion-cation pair of an ionic liquid and for inserting this pair into the electrode of a supercapacitor. The invention also allows screening of materials/cation-anion pairs of the ionic liquid of supercapacitors. Indeed, the total energy, which is related to the capacitance of a supercapacitor, is a good screening criterion.

2. Description of the Prior Art

Electrical energy storage is an important aspect notably for hybrid and/or electric vehicle-development. Supercapacitors (or electrochemical capacitors) differ from conventional capacitors in having very high power. They are particularly well suited for applications that require energy pulses over very short times of the order of one minute.

A supercapacitor has two porous electrodes, generally made of activated carbon and impregnated with electrolyte, which are separated by an insulating porous membrane (providing ionic conduction). The electric double layer develops on each electrode-electrolyte interface, so that a supercapacitor can be schematically described as the combination in series of two capacitors, one with a positive electrode and the other with a negative electrode. Due to capacitor combination laws, the capacitance of the series combination is always lower than the lower of the two capacitances.

Unlike batteries, no chemical reaction responsible for electron transport occurs in supercapacitors, which are governed by a physical phenomenon.

During the charging period, a potential is applied to the two electrodes. The ions in the electrolyte are separated and form an electrochemical double layer. The negative electrode attracts the positive ions and the positive electrode attracts the negative ions. As soon as a current collector is used, the capacitor discharges and the double layer is destroyed.

The capacitance (C) of the capacitor is determined by the amount of charge stored (Q) and the applied potential difference (ΔV) according to:

$$C = \frac{Q}{Δ V}$$

The potential difference is expressed as a function of the charge:

$$Δ V = Ed = \frac{Q}{ɛ A} d$$

where E is the value of the electric field, ε the permittivity of the medium, A is the surface area of the electrode/electrolyte interface and d is the thickness of the double layer.

The relationship expressing capacitance is:

$$C = \frac{ɛ A}{d}$$

For an electrode, the capacitance thereof increases when the surface area of the interface is increased and the thickness of the double layer is decreased. The thickness can be decreased when the ions are robbed of their solvent molecules (water, acetonitrile) or their counterion. The ionic liquids family (salts liquid at a temperature below 100° C.) has the ability/property to be robbed of their counterion.

In order to optimize the capacitance of supercapacitors using an ionic liquid, many materials/cation-anion pairs of ionic liquid need to be tested.

A method for carrying out such screening determines for each pair the total energy (ΔEtot) for desolvating an ionic liquid (anion+cation) pair and adsorbing it in the pores of the electrode. It appears that this total energy is inversely proportional to the capacitance.

In order to facilitate the calculation of ΔEtot, it is well known to use a thermodynamic cycle allowing ΔEtot to be divided into three energy terms whose sum is ΔEtot (Shown in FIG. 1):

1. Desolvation energy (ΔE_{desolv})

It corresponds to the energy required to transfer an ionic liquid (cation+anion) pair from the condensed phase (ionic liquid, pure or dissolved in a solvent such as acetonitrile) into the gas phase. This technique is notably described in the document: T. Koddermann, D. Paschek, R. Ludwig, ChemPhysChem 2008, 9, 549.

2. Dissociation Energy (ΔE_{diss})

It represents the energy required to dissociate the cation and the anion. This technique is notably described in the document: Shimizu, K.; Tariq, M.; Cost Gomes, M. F.; Rebelo, L. P. N.; Canongia Lopes, J. N. The Journal of Physical Chemistry, B. 2010, 114, 5831-4.

3. Adsorption Energy (ΔE_{ads})

It is released when the ion penetrates into the pores of the electrode. Within the context of a supercapacitor, the adsorption energy of the anion (ΔE_{ads-an}) and the adsorption energy of the cation (ΔE_{ads-cat}) are calculated.

FIG. 1 illustrates this strategy allowing calculation of the total energy required to remove a cation and an anion from their condensed phase and to adsorb them in the pores of the electrode.

However, determination of the adsorption energy using this thermodynamic cycle requires accounting for the short- and long-range electrostatic interactions between the ions (referred to as guests) and the electrode (host). Now, the constraints imposed by the calculation formality do not allow these interactions to be accounted for even though they are essential.

### SUMMARY OF THE INVENTION

Thus, the invention relates to a method for determining the adsorption energy of anion-cation pairs in a supercapacitor, while accounting for the electrostatic interactions between the ions and the electrode.

The invention also relates to a method for screening anion-cation pairs and to a method for sizing the pores of the electrodes of a supercapacitor.

In general terms, the invention relates to a method for determining the adsorption energy between an electrically charged adsorbent and an electrically charged adsorbate, by accounting for electrostatic interactions between the adsorbate and the adsorbent. The method comprises the following stages:

constructing a simulation box (BSA) containing the adsorbent (A, B) and the adsorbate (i+, i−), as well as another adsorbent (A′, B′) of the same type but of opposite charge and another adsorbate (i′+, i′−) of the same type but of the opposite charge, so that the simulation box has a zero charge; determining the adsorption energy of the adsorbates (i+, i− and i′) in the first simulation box (BSA) through molecular simulation and using the Ewald method, and deducing therefrom the adsorption energy of the adsorbate (i+, i−) on the adsorbent (A, B).

According to the invention, the adsorbent can be a zeolite, or a nanotube or an enzyme or an electrode (A, B), and the adsorbate can be an ion (i+, i−) or a protein.

According to one embodiment, the adsorption energy of an anion-cation pair of an ionic liquid is determined on two electrodes of a supercapacitor by taking into account electrostatic interactions between the ions and the electrode, by carrying out the following stages:
constructing a first simulation box (BSA) comprising the positive electrode A and at least one anion, as well as an electrode A′ of opposite charge and at least one ion of opposite charge, so that the simulation box has a zero charge;
constructing a second simulation box (BSB) comprising the negative electrode B and at least one cation, as well as an electrode B′ of opposite charge and at least one ion of opposite charge, so that the simulation box has a zero charge;
determining an electrostatic contribution of the adsorption energy of the ions in the first simulation box (BA) using the Ewald method, and deducing therefrom the adsorption energy of the anions;
determining an electrostatic contribution of the adsorption energy of the ions in the second simulation box (BSB) using the Ewald method, and deducing therefrom the adsorption energy of the cations.

A total energy ΔEtot can be determined for desolvating the anion-cation pair of a solvent and for inserting the pair into two electrodes of a supercapacitor by carrying out the following stages:

determining a desolvation energy (ΔE_{desolv}) of the anion-cation pair;

determining a dissociation energy (ΔE_{diss}) of the anion-cation pair;

determining the adsorption energy (ΔE_{ads}) of the anion-cation pair by the method according to the invention;

determining the change in the total energy (ΔEtot) by summing the desolvation energy, the dissociation energy and the adsorption energy.

According to the invention, the desolvation energy (ΔE_{desolv}) can be determined by performing a first molecular dynamic simulation to calculate the average total energy of the condensed phase at a given temperature, and a second molecular dynamic simulation to calculate the average total energy for a single ion pair, and the dissociation energy (ΔE_{diss}) can be determined by determining the energy of the anion—cation pair, the energy of the cation and the energy of the anion.

According to one embodiment, screening of the materials that make up the electrodes of a supercapacitor is performed by carrying out the following stages:

selecting an anion-cation pair for the ionic liquid;

determining the total energy ΔEtot for the ions for different pore sizes of the electrodes by the method according to the invention;

determining the pore size allowing obtaining a maximum capacitance by selecting the pore size corresponding to the minimum total energy ΔEtot.

Screening cation-anion pairs of the ionic liquid of a supercapacitor can be performed by carrying out the following stages:
selecting a pore size for the electrodes;
determining the total energy ΔEtot for different anion-cation pairs for the pore size by the method according to the invention; and
selecting the anion-cation pair allowing obtaining a maximum capacitance by selecting the pair having the minimum total energy (ΔEtot) for the pore size.

### BRIEF DESCRIPTION OF THE DRAWINGS

Other features and advantages of the method according to the invention will be clear from reading the description hereafter of embodiments given by way of non-limitative example, with reference to the accompanying figures wherein:

FIG. 1 illustrates the strategy allowing calculating the total energy required to remove a cation and an anion from their condensed phase and to adsorb them in the pores of the electrode using a thermodynamic cycle allowing ΔEtot to be divided into three energy terms whose sum is ΔEtot

FIG. 2 illustrates the two simulation boxes used for each electrode which for each simulation box, the electrode is duplicated by taking up its opposite charge,

FIG. 3 illustrates in detail a simulation box for calculating the adsorption enthalpy, which contains two nanotubes with opposite charges.

FIG. 4 shows adsorption energy, Van der Waals and electrostatic curves for cations TEA and EMIM and anions BF4 and TFSI as a function of the pore size of the electrode; and

FIG. 5 shows a normalized capacitance curve (the fartherest right curve) and a total energy curve (the fartherest left curve) for the EMIM/TFSI pair.

### DETAILED DESCRIPTION OF THE INVENTION

The invention is a method for simulating electrostatic (Coulombian) interactions between an electrically charged adsorbent and an electrically charged adsorbate. Examples thereof are:
ion in a zeolite
ion in a MOF (metal organic framework)
ion in a nanotube
protein in an enzyme.

In particular, the invention is a method for determining the total energy for desolvating an anion-cation pair of an ionic liquid and for inserting this pair into the electrode of a supercapacitor.

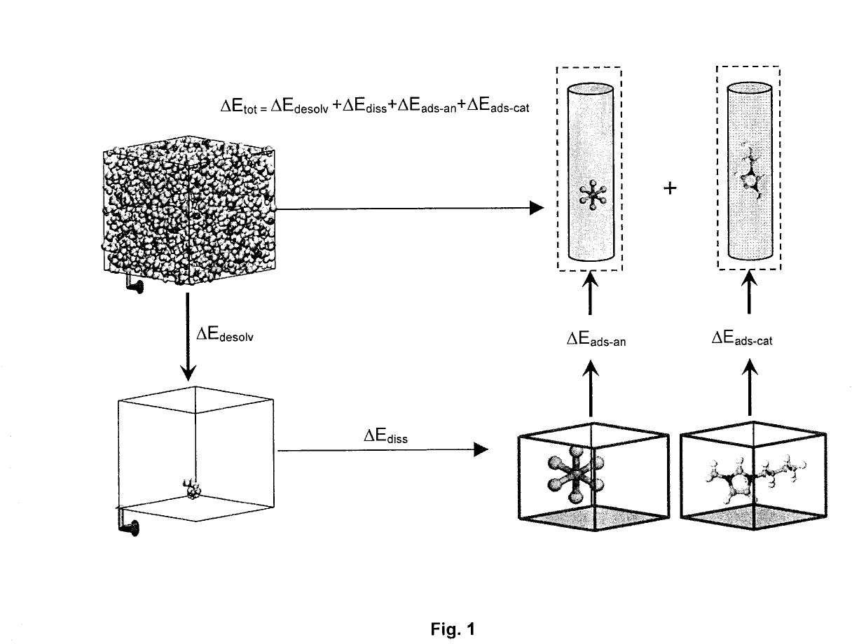

As illustrated in FIG. 1, a thermodynamic cycle allowing the total energy ΔEtot to be divided into three energy terms whose sum is ΔEtot is used.

The method then comprises the following stages:
1. Determining desolvation energy (ΔE_{desolv})
2. Determining dissociation energy (ΔE_{diss})
3. Determining adsorption energy (ΔE_{ads})

1. Determining Desolvation Enemy (ΔE_{desolve})

The desolvation energy corresponds to the energy required to transfer an ionic liquid (cation+anion) pair from the condensed phase (ionic liquid, pure or dissolved in a solvent such as acetonitrile) into the gas phase. Two simulations are required to calculate it which are:

i) a molecular dynamic simulation is performed to calculate the average total energy of the condensed phase (with n ion pairs) at a given temperature: E1. Such a technique is for example described in the following documents:
Allen, M. P.; Tildesley, D. J. Computer Simulation of Liquids; Oxford: Clarendon press, Ed.; 1987th ed.; Oxford University Press: Oxford, 1987.
Frenkel, D.; Smit, B. Understanding Molecular Simulation; 2nd ed.; Academic Press: London, 2002; p. 638.

ii) a molecular dynamic simulation is performed to calculate the average total energy for a single ion pair (cation+anion): E2.

The desolvation energy thus is the difference between E1 divided by the number of pairs (n) and E2, that is: ΔE_{desolv}=E1/n−E2.

Such a technique is for example described in the following document:
Shimizu, K.; Tariq, M.; Costa Gomes, M. F.; Rebelo, L. P. N.; Canongia Lopes, J. N. The Journal of Physical Chemistry, B 2010, 114, 5831-4.

2. Determining Dissociation Energy (ΔE_{diss})

The dissociation energy represents the energy required to dissociate the cation and the anion. It is calculated from three quantum calculations:
i) the energy of the cation+anion pair: E3
ii) the energy of the cation: E4
iii) the energy of the anion: E5.

The expression is: ΔE_{diss}=E3-E4-E5.

Such a technique is for example described in the following document:
Fernandes, A. M.; Rocha, M. A. A.; Freire, M. G.; Marrucho, I. M.; Coutinho, J. A. P.;
Santos, L. M. N. B. F. The Journal of Physical Chemistry. B 2011, 115, 4033-41.

3. Determining Adsorption Energy (ΔE_{ads})

The adsorption energy is the energy released when the ion is inserted into the pores of the electrode represented by carbon nanotubes according to the invention.

The adsorption energy is calculated by a molecular simulation where the short- and long-range electrostatic interactions are calculated using the Ewald method, as follows:

ΔE_{ads}=E_{electrode+ion}−E_{electrode}−Eᵢₒₙ

where E_{electrode+ion}, E_{electrode} and Eᵢₒₙ correspond to the energy of the electrode and of the ion, to the energy of the electrode alone and to the energy of the ion alone respectively. This energy is the energy calculated with a force field whose parameters have been optimized to fully describe the ionic liquids. This force field can be based on the following references:
Canongia Lopes, J. N.; Deschamps, J.; Padua, A. A. H. The Journal of Physical Chemistry B 2004, 108, 11250.
   Canongia Lopes, J. N.; Padua, A. A. H. The Journal of Physical Chemistry B 2006, 110, 19586-19592.

Canongia Lopes, J. N.; Padua, A. A. H. The Journal of Physical Chemistry B 2004, 108, 16893-16898.

De Andrade, J.; Bo, E. S.; Stassen, H. Journal of Physical Chemistry B 2002, 3546-3548.

Kaminski, G. A.; Jorgensen, W. L. Journal of the Chemical Society, Perkin Transactions 2, 1999, 2365-2375.

Each potential energy (E^{pot}) can be broken down into two principal terms: the intramolecular energy (Eᵢₙₜᵣₐ) and the intermolecular energy (Eᵢₙₜₑᵣ). For example:

E_{electrode+ion}^{pot}=E_{electrode+ion}^{Intra}+E_{electrode+ion}^{Inter}=E_{electrode+ion}^{Intra}+E^{electrode+ion}^{VanderWaals}+E_{eletrode+ion}^{electrostatic}

The first term (Eᵢₙₜᵣₐ) takes into account the interactions between atoms linked by a bond, an angle or a dihedral angle. The second term (Eᵢₙₜₑᵣ) contains the so-called non-binding interactions: Van der Waals and electrostatic.

In general terms, the potential energy of a species (ion, electrode, ion pair) is defined by:

$${E}^{pot} = {E}^{intra} + {E}^{inter}$$

$${E}^{intra} = {E}^{bonds} + {E}^{angles} + {E}^{dihedral} = {\sum }_{bonds} \frac{{k}_{i}}{2} {( {l}_{i} - {l}_{i , 0} )}^{2} + {\sum }_{angles} \frac{{k}_{i}}{2} {( {θ}_{i} - {θ}_{i , 0} )}^{2} + {\sum }_{dihedral} \frac{{V}_{n}}{2} ( 1 + cos ( n ω - γ ) )$$

$${E}^{inter} = {E}^{VanderWaals} + {E}^{electrostatic} = {\sum }_{i = 1}^{N} {\sum }_{j = i + 1}^{N} 4 {ɛ}_{ij} [ {( \frac{{σ}_{ij}}{{r}_{ij}} )}^{12} - ] [ {( \frac{{σ}_{ij}}{{r}_{ij}} )}^{6} ] + {E}^{electrostatic}$$

with:

lᵢ is the length of bond i.

l_{i,0} is the reference distance for this bond.

⊖ᵢ is the magnitude of angle i.

⊖_{i,0} is the reference for this angle.

ω is the dihedral angle.

Vₙ is the constant for the dihedral angle.

γ is the constant for the dihedral angle.

εᵢⱼ is the reference energy for a pair of atoms i and j.

O′ᵢⱼ is the reference distance for a pair of atoms i and j.

This definition is notably described in: Leach, A. R. Molecular Modelling: Principles and Applications; 2nd ed.; Prentice Hall, 2001.

Electrostatic interactions have a (very) long range. Therefore, even charged atoms (or bodies) separated by long distances undergo an electrostatic interaction. To take account of this interaction, the Ewald method is very commonly applied. The Ewald method is a widely used method for molecular simulation. It allows assessing electrostatic interactions at short distances in a real space and at long distances in a reciprocal space, so that the summation converges to a certain value.

The Ewald method is a method for calculating the interaction energies of periodic systems and more particularly electrostatic energies. Electrostatic energies comprise both short- and long-range interaction terms. It is very interesting to break down the interaction potential into short-range terms whose summation is performed in the real space and long-range terms whose summation is performed in the Fourier space (reciprocal space). The advantage of this approach lies in the fast convergence of the summation in the Fourier space in comparison to its equivalent in the real space in the case of long-distance interactions.

All the atoms of the cation and the anion have a partial net charge. Each atom is thus considered as a “point charge”. Then, each “point charge” in the system contributes to the total electrostatic energy that is calculated with the formula as follows:

$${E}_{elec} = \frac{1}{2} {\sum }_{i = 1}^{N} {\sum }_{j = 1}^{N} \{ \begin{matrix}{\sum }_{\vert n \vert = 0}^{∞} \frac{{q}_{i} {q}_{j}}{4 π {ɛ}_{0}} \frac{erfc ( α \vert {r}_{ij} + n \vert )}{\vert {r}_{ij} + n \vert} + \\ {\sum }_{k \neq 0} \frac{1}{π {L}^{3}} \frac{{q}_{i} {q}_{j}}{4 π {ɛ}_{0}} \frac{4 {π}^{2}}{{k}^{2}} exp ( - \frac{{k}^{2}}{4 {α}^{2}} ) cos ( k \cdot {r}_{ij} ) - \\ \frac{α}{\sqrt{π}} {\sum }_{k = 1}^{N} \frac{{q}_{k}^{2}}{4 {πɛ}_{0}}\end{matrix} \}$$

where:
the 1^{st} term presents the contribution in the real space
the 2^{nd} term presents the contribution in the reciprocal space
the 3^{rd} term presents a correction for the interactions between each Gaussian with itself.

With (definition of the principal variables):

E_{elec} is the electrostatic energy (interaction between two electrically charged particles).

qᵢ or qⱼ is the net atomic charge of atoms i and j.

rᵢⱼ is the distance between atoms i and j carrying a charge qi and qj respectively.

N is the total number of atoms carrying a charge (atoms of the electrode+atoms of the iionic liquid).

n liquid (nₓL, n_{y}L, n_{z}L) and nₓ, n_{y}, n_{z} are integers.

L is the length of the box.

Erfc is the complementary error function:

$$f ( x ) = \frac{1}{α \sqrt{2 π}} exp ( - \frac{{( x - μ )}^{2}}{2 {α}^{2}} )$$

α defines the “width” of the Gaussian function:

$$erfc ( x ) = \frac{2}{\sqrt{π}} {\int }_{x}^{∞} exp ( - {t}^{2} ) d t$$

k equals 2πn/L (reciprocal vector)

k is the norm of vector k.

The Ewald method calculates the electrostatic part. However, this method requires the total charge in the simulation box to be zero (neutral), or otherwise the second term in Equation (3) does not converge. The simulation box is a representation which is a model of the physical environment where the phenomena are studied.

Now, direct simulation of the physical system when an ion is inserted in the electrode implies that either the electrode alone is charged, or the electrode+ion system is charged. As a result, the Ewald method is no longer applicable.

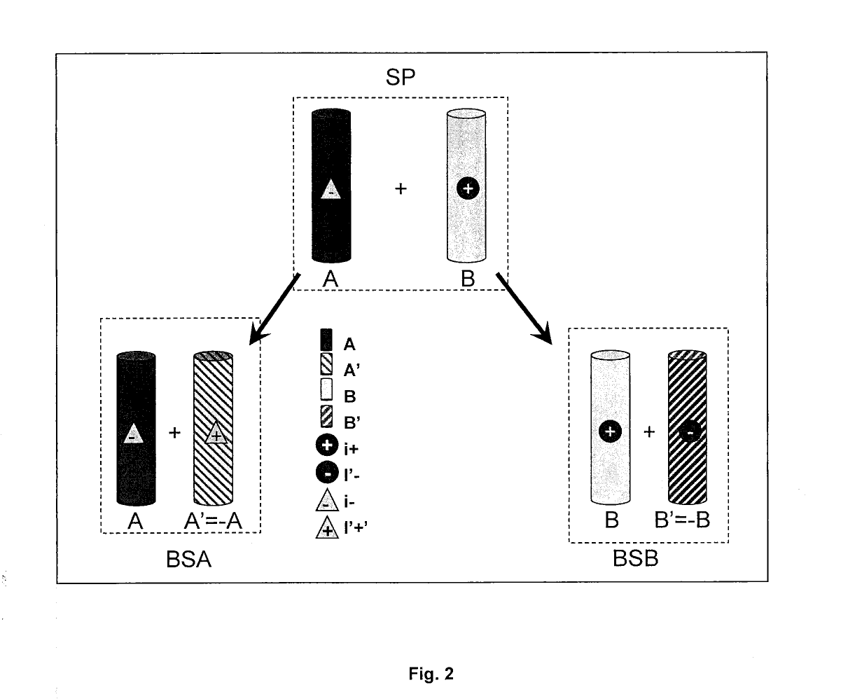

In order to overcome this problem, the method according to the invention is based on a simulation box where each electrode is duplicated by taking up an exactly opposite charge, as illustrated in FIG. 2.

Thus, according to the invention, two simulation boxes BSA and BSB are constructed from the physical system (SP).

The positive electrode A and the anion (i−) in the physical system are studied within a simulation box BSA comprising electrode A and anion (i−), as well as an electrode A′ of opposite charge and an ion (i′+) of opposite charge.

The negative electrode B and the cation (i+) in the physical system are studied within a simulation box BSB comprising electrode B and cation (i+), as well as an electrode B′ of opposite charge and an ion (i′−) of opposite charge.

In order to ensure electroneutrality in each simulation box, the number of cations and cations of opposite charge (cation′) is identical so that the total charge is zero. Similarly, the charges of electrodes A and A′ cancel each other out.

Thus, the Ewald method can be applied.

In order to obtain the adsorption energy of the anion in electrode A, the adsorption energy (ΔE_{ads}=E_{électrode+ion}−E_{électrode}−Eᵢₒₙ) calculated in simulation box BSA is divided by 2.

In order to obtain the adsorption energy of the cation in electrode B, the interaction energy calculated in simulation box BSB is divided by 2.

Thus, in more detail, each electrode is modelled by nanotubes of infinite length separated by a distance d and having exactly the same absolute electric charge, but opposite so that the total charge is zero. Distance d is so selected that the two nanotubes are distant enough from one another for the electrostatic and Van der Waals interactions to become negligible. Each nanotube is then filled with exactly the same number (1, 2, 3 . . . ) of ions of same nature, but with opposite atomic charges. One or more anions can thus be put in the nanotube with a positive charge and in the second nanotube a negative charge with the same anion, but with its opposite atomic charges so as to become a cation.

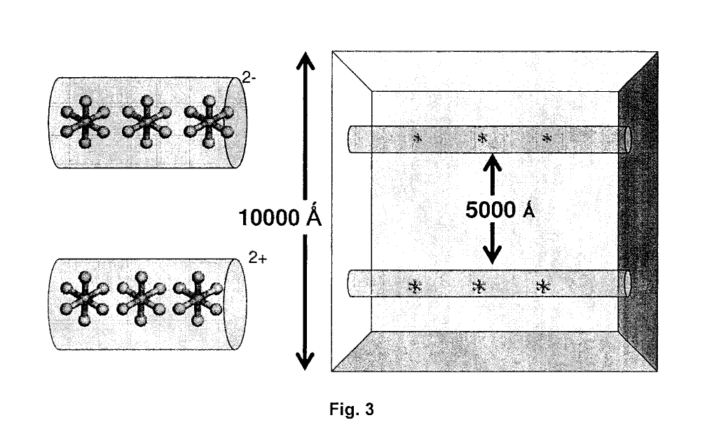

This representation is illustrated in FIG. 3. The top nanotube carries a charge of 2 and the bottom nanotube carries the same absolute charge, but is opposite (2+). The bottom nanotube is charged with three (hexafluorophosphate) [PF6]− anions, therefore the total charge of the sub-system is −1, whereas the top nanotube is charged with three anions with opposite charges [PF6]+, so that the total charge of this sub-system is +1 and the total charge of the simulation box is zero.

Note that there are only opposed the atomic charges. All the other parameters of the force field (set of equations and parameters describing the potential energy of a system of particles) remain identical, so that the total internal energy is exactly the same for the two species (anions and cations). Electroneutrality is thus always provided or the total system because the nanotubes have an opposite charge, like the two ions. The Ewald method can thus be used to assess the electrostatic interactions.

Using this approach involves several advantages:

1. Electroneutrality is always provided for the total system because the nanotubes have an opposite charge, like the two ions. The Ewald method can thus be used to assess the electrostatic interactions.

2. The total charge of a nanotube filled with a number of ions does not need to be zero because this net charge is compensated for by the charge of the other nanotube having the same number of ions (but of opposite charge). This approach allows:
a) varying the number of ions in each nanotube regardless of the charge of the nanotube. Thus, with a constant electric charge of the nanotube, the maximum number of ions (anions or cations) that can enter the nanotube can be studied; and
b) varying the charge of the nanotube regardless of the number of ions inserted. If the diameter of the nanotube is “too small” in relation to the size of the ion, to make it fit by increasing the charge of the nanotube, the electrostatic interactions can compensate the deformation energy of the ion.

3. Since simulation of the system leads to a calculation corresponding to twice the average interaction energy between ion and nanotube (an average energy for each nanotube), the statistics for calculating the average adsorption energy is also improved.

### Examples

### Adsorption Energies

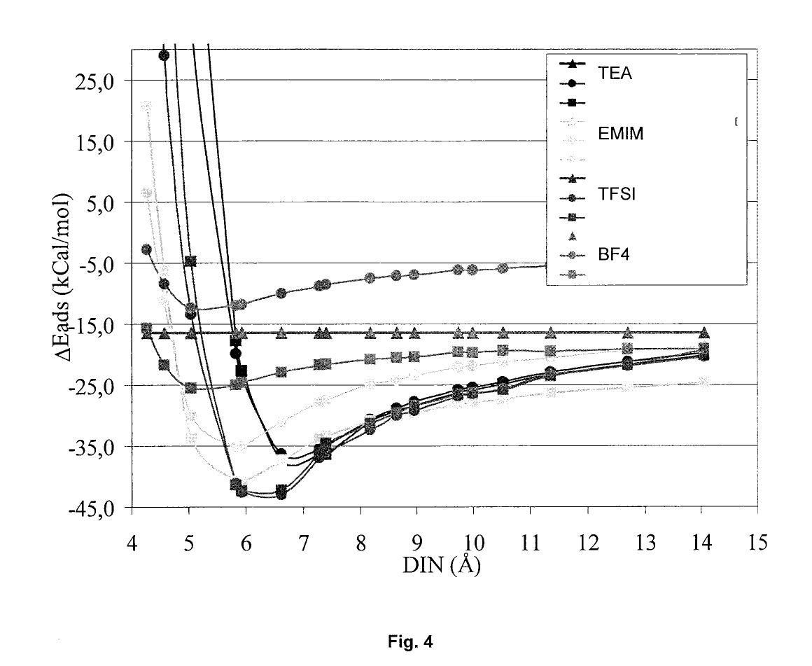

In FIG. 4, the adsorption energy (ΔE_{ads}) has been broken down with contribution from the Van der Waals interactions (E_{vdw}) and the electrostatic interactions (E_{electro}). The Van der Waals interactions (E_{vdw}) are represented by circles, the electrostatic interactions (E_{electro}) by triangles and the adsorption energy (ΔE_{ads}) by squares.

These energies are plotted as a function of the inside diameter of the nanotube (DIN), this diameter modelling the pore size of the electrode, for the tetraethylammonium (TEA+) and ethylmethylimidazolium (EMIM+) cations, respectively for the tetrafluoroborate (BF₄⁻) and bis(trifluoromethanesulfonyl)imide (TFSI⁻) anions.

The results show, for a constant charge (±2e per nanotube), that the electrostatic contribution is independent of the pore size of the electrode and of the nature of the ion. It is in fact entirely determined by the total charge (always ±1e) of the ion and of the nanotube (always±2e).

On the other hand, the adsorption energy shows a curve with a minimum and the shape thereof is imposed by the shape of the curve representing the contribution of the Van der Waals energy.

The minima of the adsorption energy curves shown in FIG. 4 depend on the size of the ions. The smaller ions in geometric size (BF₄ and EMIM) can enter the nanotubes with small diameters (5 to 6 Å). That is, the adsorption energy is negative as long as the DIN is greater than about 4.5 Å, whereas the larger ions are excluded. That is, the adsorption energy becomes positive as soon as the DIN is below about 5.5 Å (TFSI) or 6 Å (TEA) (FIG. 4).

It can also be noted that the interaction energy (depth of the well) between the ion and the host is greater for ions of a larger number of atoms (TFSI: 15 atoms; EMIM: 19 atoms; NEt₄: 29 atoms) than for ions with a small number of atoms (BF₄⁻: 5 atoms). This interaction is higher because each atom contributes to the total sum of the Van der Waals interactions. Note that the shape of the ion also plays an important role: an ion with an “elongate” geometry such as TFSI has a higher interaction with a cylinder (nanotube) than an ion with a more spherical geometry such as NEt₄.

Examples of Application of the Method

Using the method according to the invention in order to determine the total energy (ΔEtot) for desolvating an ionic liquid anion+cation pair and adsorbing it in the pores of the electrode, taking into account the electrostatic energies, allows predicting the capacitance of the supercapacitor as a function of the pore size of the electrodes or of the anion-cation pairs in the ionic liquid.

It is then possible to determine an electrode pore size allowing obtaining a maximum capacitance of the supercapacitor for a given ionic liquid.

It is also possible to determine anion-cation pairs allowing obtaining a maximum capacitance of the supercapacitor for a given electrode pore size.

Predicting the Capacitance of the Supercapacitor as a Function of the Pore Size

It is experimentally observed that a (measured) capacitance curve and a curve representing the total energy (ΔEtot) determined according to the invention (taking account the pore size distribution) have their maximum, respectively their minimum, substantially for the same pore size.

Thus, the curve representing the total energy is a very good indicator for assessing the optimum pore size of the electrode.

The method for screening the materials that make up the electrodes of a supercapacitor then comprises the following stages:

selecting an anion-cation pair for the ionic liquid (electrolyte of the supercapacitor),
determining the total energy (ΔEtot) for these ions for different electrode pore sizes using the method according to the invention, and
determining the pore size allowing obtaining a maximum capacitance by selecting the pore size corresponding to the minimum energy (ΔEtot).

### Example

The following anion-cation pair is selected: EMIM/TFSI.

The total energy of these ions is determined for different electrode pore sizes by applying the method according to the invention.

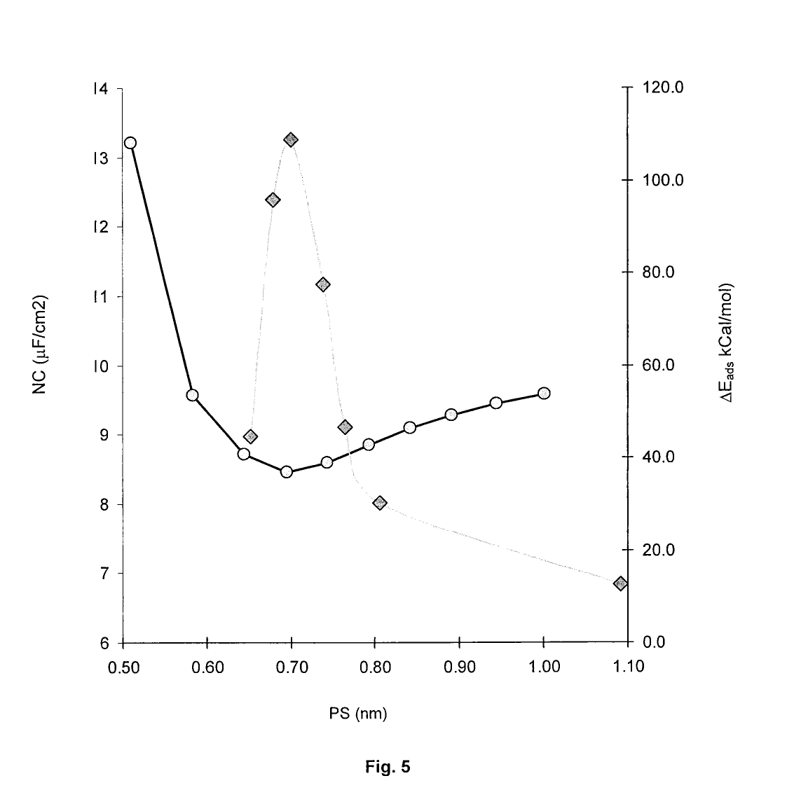

The total energy curves exhibit an analogy with the normalized capacitance experimentally measured by P. Simon et al. (Science (New York, N.Y.) 2006, 313, 1760-3). This can be seen in FIG. 5 that illustrates, on the one hand, the evolution of the normalized capacitance (NC—curve with diamonds) of the supercapacitor (with the EMIM/TFSI pair), experimentally measured as a function of the pore size (PS), and on the other hand the evolution of the total energy (ΔEₜₒₜ−curve with circles) as a function of the pore size.

It is observed that the maximum of the “capacitance” curve and the minimum of the ΔEₜₒₜ curve are reached for a pore size substantially equal to 0.7 nm.

This pore size thus is the optimal pore size for a supercapacitor operating with the EMIM/TFSI pair.

Predicting the capacitance of the supercapacitor as a function of the anion-cation pairs

Conversely, for determining anion-cation pairs allowing obtaining a maximum capacitance of the supercapacitor for a given electrode pore size, the method comprises the following stages:
selecting a pore size for the electrodes;
determining total energy (ΔEₜₒₜ) for different anion-cation pairs for the pore size with the method according to the invention; and
selecting the anion-cation pair allowing obtaining a maximum capacitance by selecting a pair having a minimum total energy (ΔEₜₒₜ) for the pore size.

1-7. (canceled)

8. A method for determining adsorption energy between an electrically charged adsorbent and an electrically charged adsorbate while accounting for electrostatic interactions between the adsorbate and the adsorbent, comprising:
constructing a simulation box containing adsorbent and the adsorbate and another adsorbent of a same type but of an opposite charge and another adsorbate of a same type but of an opposite charge, so that the simulation box has a zero charge; and
determining the adsorption energy of the adsorbates in the simulation box through molecular simulation and using an Ewald method, and determining therefrom the adsorption energy of the adsorbate on the adsorbent.

9. A method as claimed in claim 8, wherein the adsorbent is one of a zeolite, a nanotube, an enzyme or an electrode, and the adsorbate is an ion or a protein.

10. A method as claimed in claim 9, wherein the adsorption energy of an anion-cation pair of an ionic liquid is determined for two electrodes of a supercapacitor by accounting for electrostatic interactions between ions and an electrode, comprising:
constructing a first simulation box comprising a positive electrode and at least one anion as well as an electrode of negative charge and at least one ion of negative charge to cause the simulation box to have a zero charge;
constructing a second simulation box comprising the negative electrode and at least one cation, an electrode of negative charge, and at least one ion of negative charge to cause the simulation box to have a zero charge;
determining an electrostatic contribution of the adsorption energy of the ions in the first simulation box using an Ewald method and determining therefrom the adsorption energy of the anions; and
determining an electrostatic contribution of the adsorption energy of the ions in the second simulation box using an Ewald method and deducing therefrom the adsorption energy of the cations.

11. A method as claimed in claim 10, wherein a total energy for desolvating the anion-cation pair of a solvent and for inserting the pair into two electrodes of a supercapacitor comprises:
determining a desolvation energy of the anion-cation pair;
determining a dissociation energy of the anion-cation pair;
determining the adsorption energy of the anion-cation pair; and
determining a change in total energy by summing the desolvation energy, the dissociation energy and the adsorption energy.

12. A method as claimed in claim 11, wherein:
determining the desolvation energy by performing a first molecular dynamic simulation to calculate an average total energy of a condensed phase at a given temperature and a second molecular dynamic simulation to calculate an average total energy for a single ion pair; and
determining the dissociation energy by determining energy of the anion-cation pair, energy of the cation, and energy of the anion.

13. A method as claimed in claim 10, comprising:
screening materials that make up electrodes of a supercapacitor by selecting an anion-cation pair for the ionic liquid;
determining total energy for the ions for different pore sizes of the electrodes; and
determining a pore size which allows obtaining a maximum capacitance by selecting a pore size corresponding to the minimum total energy.

14. A method as claimed in claim 11, comprising:
screening materials that make up electrodes of a supercapacitor by selecting an anion-cation pair for the ionic liquid;
determining total energy for the ions for different pore sizes of the electrodes; and
determining a pore size which allows obtaining a maximum capacitance by selecting a pore size corresponding to the minimum total energy.

15. A method as claimed in claim 12, comprising:
screening materials that make up electrodes of a supercapacitor by selecting an anion-cation pair for the ionic liquid;
determining total energy for the ions for different pore sizes of the electrodes; and
determining a pore size which allows obtaining a maximum capacitance by selecting a pore size corresponding to the minimum total energy.

16. A method as claimed in of claim 10, comprising:
screening cation-anion pairs of the ionic liquid of a supercapacitor by selecting a pore size for the electrodes;
determining total energy for different anion-cation pairs for the pore size; and
selecting an anion-cation pair allowing obtaining a maximum capacitance by selecting the pair having the minimum total energy for the pore size.

17. A method as claimed in of claim 11, comprising:
screening cation-anion pairs of the ionic liquid of a supercapacitor by selecting a pore size for the electrodes;
determining total energy for different anion-cation pairs for the pore size; and
selecting an anion-cation pair allowing obtaining a maximum capacitance by selecting the pair having the minimum total energy for the pore size.

18. A method as claimed in of claim 12, comprising:
screening cation-anion pairs of the ionic liquid of a supercapacitor by selecting a pore size for the electrodes;
determining total energy for different anion-cation pairs for the pore size; and
selecting an anion-cation pair allowing obtaining a maximum capacitance by selecting the pair having the minimum total energy for the pore size.
